(19) United States
(12) Patent Application Publication
(10) Pub. No.: US 2011/0200737 A1
(43) Pub. Date: Aug. 18, 2011

(54) COMPOSITION TO ENHANCE COGNITIVE ACTIVITY

(76) Inventor: Winston Suyanto, Coto De Caza, CA (US)

(21) Appl. No.: 12/705,924

(22) Filed: Feb. 15, 2010

(51) Int. Cl. A23J 1/08

(52) U.S. Cl. 426/657

(57) ABSTRACT

A nutritional supplement composition is disclosed for enhancement of brain activity. Brain activity is a very complex mechanism, but scientists have now been able to isolate the specific compounds which act as promoters of neuro impulses, or act as neurotransmitters by themselves. The inventive formulation uses 9-10 day incubated fertilized hen eggs to derive a highly potent di and tripeptide based amino acid base. The rapid transport across the intestinal membrane of di and tripeptides is further exploited by addition of Glycine bearing marine protein, such as shark cartilage and vegetable protein to deliver a potent dose to the neuro system.

A nutritional supplement composition is disclosed for enhancement of brain activity. Brain activity is a very complex mechanism, but scientists have now been able to isolate the specific compounds which act as promoters of neuro impulses, or act as neurotransmitters by themselves. While the medical and pharmaceutical community has designed many synthetic drugs for various disorders associated with the brain, there remains a need for a potent natural formulation to address the nourishment of the brain.

The supplement is based on the well-founded knowledge of the role of peptides, Glycine and glutamic acid as neurotransmitters. The inventors have discovered surprising results from consumers regarding memory recall and other cognitive functions.

It is an object of this invention to provide consumers with an all-natural formulation for a nutritional supplement, which can enhance their brain activity. It is a further object of this invention to provide an all-natural formulation to consumers to provide branched chain amino acids and other nutrients to nourish the Hypothalamus of the brain. Such nourishment enhances the ability of the Hypothalamus to secrete the required hormones that regulate weight, levels of cortisone and other harmful stress related hormones. It is also an object of this invention to disclose the high absorption and fast diffusivity of an all-natural source of oligopeptides. It is yet another object of this invention to utilize the oligopeptides as a carrier to bring crucial amino acids such as glutamic acid and Glycine to the brain.

The composition, to be known as brand name “OPT-9” soon, consists of the following key ingredients:

Blastodermal and protoembryonic stage extract from the Hen's egg: 51%
Marine protein extract, specifically shark cartilage: 44%
Phytoprotein extract, specifically pea protein extract: 04%

The ingredients, their amino acid analyses, and benefits of these amino acids to the human body are disclosed and explained below, with the benefits of the composition becoming obvious to those in the field of nutrition, pharmaceuticals and medicine.

Blastodermal and protoembryonic stage extract (BPE): The health benefits of the hen egg have been known for centuries. Recently, further investigation of the mechanism of the development of an embryo in an egg during incubation revealed the scientific equivalent of the “miracle of life”. In earlier studies, while monitoring weight gain of the embryo during the incubation period, Murray (1925) found very little gain in the first 9-10 days (7.5%), and then a sharp increase (1190% by end of incubation), suggesting rapid development of a body. The potency and particular composition of the nutrients available to the embryo at this stage, termed the Blastodermal or protoembryonic stages has been assumed to be unique, and critical in the formation of the living creature from an embryo. U.S. Pat. No. 5,641,517 discloses the chemical composition of the original egg solids for the blastodermal to protoembryonic stages. Table 1 lists the amino acids and their weight percentages from the patent documentation.

| | g/Kg |
|---|---|
| Cystine | 27 |
| Methionine | 27 |
| Aspartic Acid | 86 |
| Threonine | 37 |
| Serine | 56 |
| Glutamic Acid | 110 |
| Proline | 29 |
| Glycine | 30 |
| Alanine | 49 |
| Valine | 57 |
| Isoleucine | 48 |
| Leucine | 71 |
| Tyrosine | 33 |
| Phenylalanine | 48 |
| Histidine | 22 |
| Ornitine | 0.1 |
| Lysine | 58 |
| Arginine | 48 |
| Hydroxyproline | 0.1 |
| Ammonia | 14 |
| Branched | 179 |
| Chain | |

Specifically, during the blastodermal to protoembryonic stages of embryogenesis, oligopeptides with molecular weights from 0.5 to 1.0 kD were identified. Oligopeptides are compounds, which have 2 to 20 amino acids joined by a peptide bond. These short chains of amino acids are able to cross the digestive barrier without breaking down.

Peptides are the most common Neurotransmitters in the hypothalamus part of the brain. Unlike antidepressants, which target the adrenal glands with biostimulants, BPE regulates the release of hormones produced by the adrenal glands, such as androgens, estrogens, glucocorticoids, mineral corticoids, adrenaline and noraadreneline. Specifically, BPE helps to regulate the adrenal 17-ketosteroid sulphates and the 7-hydroxycorticosteroids, which improve anabolism through increased synthesis of androgens and a decrease in the catabolic hormone cortisol, which has been associated with multiple health problems, including weight gain, depression, memory loss, etc. Clinical studies for depression alleviation by BPE were performed at Med-Eq Ltd., and ETC Research Ltd. In Norway.

Peptides are far more potent than other neurotransmitters, requiring only small amounts to produce a profound effect. These embryonic peptides have been isolated through a patented process (U.S. Pat. No. 5,641,517) precisely at the right stage of incubation, extracted and freeze dried.

The present invention builds on the encouraging results obtained through studies at Med-Eq Ltd., and ETC Research, Ltd in Norway for control of depression in adults by administering suitable doses of BPE. The neurological benefits associated with BPE may be attributed to the rapid assimilation of the oligopeptides, and hence blending other beneficial amino acids with BPE for specific target functions can be achieved.

Adding specific, targeted vegetable protein ingredients: Vegetable protein, specifically legume protein, has an essential amino acid profile, which is very close to that of the ideal protein for human nutrition (FAO/WHO 1985 and 2002). The result is high in Glutamic acid, (further enhancing the cognitive function of the brain), branched chain amino acids (to counter insomnia), Lysine (to control release of serotonin, controlling moods) and Arginine (promoting NO and growth hormone formation). The specially isolated pea protein therefore adds a synergistically potent composition to enhance brain activity.

Shark cartilage and its health benefits have been known for centuries. The high Glycine level in shark cartilage is combined with a significant amount of hydroxyproline to stabilize the Glycine. By itself, Glycine is a neurotransmitter, primarily utilized by the brain to control glutamate levels. As a combination with BPE, it becomes a powerful force to enhance memory function in the brain.

The beneficial effects of the unique combination of amino acids in the composition described above, specifically the combination of hen egg extract with shark cartilage and pea protein should be obvious to those skilled in the nutrition and medical profession. The compositions and ranges of weight % described should not be considered limiting to the overall benefit associated by the unique combination, and thus should not be construed as outside the scope of this invention.

I claim:

1) A beneficial composition of amino acids for a nutritional supplement for brain activity using hen egg extract from the blastodermal and proembryotic stages, specifically extract derived between 9-10 days of incubation of a fertilized egg.

2) A composition according to claim 1 in which the weight percentage of hen egg extract from the blastodermal to protoembryonic stages is between 30-75%, preferably between 45-60%, and most preferably between 48-52%.

3) A composition according to claim 1 a nutritional supplement for brain activity which consists of adding a legume protein extract, such as pea protein extract between 2-20% by weight, preferably between 3-6% and most preferably between 4-5% to hen egg extract from the blastodermal to protoembryonic stages to elevate the level of branched chain amino acids, lysine, Arginine and glutamic acid and enhance nutritional value to the brain.

4) A composition according to claim 1 for a nutritional supplement for brain activity which consists of adding marine protein extract, specifically shark cartilage, between 30-70% by weight, preferably between 40-60% and most preferably between 45-55% to hen egg extract from the blastodermal to protoembryonic stages to elevate the level of glutamic acid and hydroxyproline to enhance nutritional value to the brain.
